(19) United States
(12) Patent Application Publication
(10) Pub. No.: US 2026/0217429 A1
(43) Pub. Date: Jul. 30, 2026

(54) FREESTANDING CONTAINER INCLUDING AN INTEGRATED, RECONFIGURABLE FUNNEL

(71) Applicants: Francesco Conte, Stamford, CT (US); Luke Johnson, Shelton, CT (US)

(72) Inventors: Francesco Conte, Stamford, CT (US); Luke Johnson, Shelton, CT (US)

(21) Appl. No.: 19/457,299

(22) Filed: Jan. 23, 2026

Related U.S. Application Data
(60) Provisional application No. 63/750,823, filed on Jan. 29, 2025.

(51) Int. Cl. B65D 47/00; B67C 11/00; B67C 11/02

(52) U.S. Cl. CPC B65D 47/00; B67C 11/02; B67C 2011/20

(57) ABSTRACT

A freestanding container for storing fluid having an integrated funnel that is reconfigurable between a normal configuration and in inverted configuration. In the inverted configuration, the funnel facilitates filling and emptying of the container and inhibits spillage, thereby increasing the safety of the container when used with heated fluids. A plug can be provided to seal the container, removable for filling the container.

### CROSS-REFERENCE TO RELATED APPLICATION(S)

This application claims the benefit of and priority to U.S. Provisional Application No. 63/750,823, filed Jan. 29, 2025, the entire contents of which are incorporated by reference herein.

### TECHNICAL FIELD

This application is directed to a freestanding container (e.g., a canteen, a bottle, a flask, etc.) that includes an integrated, reconfigurable funnel.

### BACKGROUND

Containers such as bottles, canteens, flasks, etc., are widely available in a variety of sizes, configurations, and materials. Known containers, however, often lack the ability to maintain themselves in an upright (vertical) orientation and can be difficult to fill.

The present disclosure addresses these deficiencies by providing a freestanding container that is configured to maintain itself in an upright (vertical) orientation and which includes an integrated, reconfigurable funnel that facilitates both filling and emptying of the container and better ensures safe use.

### SUMMARY

The present invention overcomes the problems and deficiencies of the prior art. With its freestanding feature and reconfigurable funnel, user safety is improved when used with heated fluid as compared to prior art containers.

In one aspect of the present invention, a container is provided that includes: a bladder with a base that is configured to support the container in a freestanding, vertical orientation absent handling by a user; a neck that extends from the bladder and which defines an opening to facilitate filling and emptying of the container; a funnel that extends from the neck such that the neck is positioned between the bladder and the funnel; and a plug that is configured for removable insertion into the opening.

The funnel defines a rim and is reconfigurable between a normal configuration, in which the rim is oriented towards the base, and an inverted configuration, in which the rim is oriented away from the base to facilitate filling and emptying of the container.

In some embodiments, the bladder, the neck, and the funnel may be formed from a single piece of material.

In some embodiments, the funnel may be configured such that the rim contacts an outer surface of the bladder in the normal configuration.

In some embodiments, the neck and the plug may be configured for threaded engagement.

In some embodiments, the neck may include a body and an insert that is positioned within the body. In some embodiments, the insert may define the opening. In some embodiments, the body may be formed from a first material, and the insert may be formed from a second material that is different from the first material. In some embodiments, the first material may have a first durometer, and the second material may have a second durometer that is higher than the first durometer.

The container, in some embodiments, may further include a cover plate that is positioned within the insert which in some embodiments can define an aperture and the plug may extend into the aperture.

In another aspect of the present invention, a container is provided that includes a bladder and a funnel. The funnel is connected to the bladder and is reconfigurable between a normal configuration and an inverted configuration.

In some embodiments, the bladder may define a recess that is configured to facilitate tactile engagement of the funnel by a user and repositioning of the funnel from the normal configuration into the inverted configuration.

In some embodiments, the container may be configured for use in a freestanding, upright orientation.

In some embodiments, the funnel may include a rim. The funnel may be configured in some embodiments such that the rim contacts an outer surface of the bladder when the funnel is in the normal configuration. In some embodiments, the funnel may be configured such that the rim is spaced from the bladder along a longitudinal axis of the container when the funnel is in the inverted configuration.

In some embodiments, the container may further include a neck that connects the funnel to the bladder. In some embodiments, the bladder, the neck, and the funnel may be formed from a single piece of material.

In some embodiments, the container may be formed from a food-grade material.

In another aspect of the present invention, a container is provided that includes: a bladder; a neck that is connected to the bladder; and a funnel that is connected to the neck, wherein the bladder, the neck, and the funnel are from a single piece of material such that the funnel is integrated into the container. The neck includes a body and an insert that is positioned within the body and which defines an opening to facilitate filling and emptying of the container.

In some embodiments, the body may include a first material, and the insert may include a second material that is different from the first material.

In some embodiments, the funnel may be reconfigurable between a normal configuration, in which the funnel extends towards the bladder, and an inverted configuration, in which the funnel extends away from the bladder.

### BRIEF DESCRIPTION OF THE DRAWINGS

So that those having ordinary skill in the art to which the subject disclosure pertains will more readily understand how to make and use the device disclosed herein, as well as the various components thereof, certain embodiments will be described in detail hereinbelow with reference to the drawings, which are intended to be viewed in conjunction with the detailed description that follows. According to common practice, the drawings may not be to-scale, and the dimensions illustrated may be arbitrarily expanded or reduced. Additionally, certain components, elements, and/or features may be omitted from certain drawings (e.g., in the interest of clarity).

FIG. 1 is a front, perspective view of one embodiment of the container of the present invention with an integrated funnel, the funnel shown in a normal configuration.

FIG. 2 is a top, perspective view of the container of FIG. 1 shown supported on a surface in a freestanding (upright, vertical) orientation.

FIG. 3 is a front, perspective view of the container of FIG. 1 with the funnel shown in an inverted configuration.

FIG. 4 is a top, perspective view of the container of FIG. 1 with the funnel shown in the inverted configuration.

FIG. 5 is a top, plan view of the container of FIG. 1 with the funnel shown in the normal configuration.

FIG. 6 is a (longitudinal, vertical) cross-sectional view of the container taken along line 6-6 in FIG. 3.

FIG. 7 is a top, perspective view of the container of FIG. 1 with the funnel shown in the normal configuration during the insertion and removal of a plug.

FIG. 8 is a top, perspective view of the container of FIG. 1 with the funnel shown in the inverted configuration during the insertion and removal of the plug.

FIG. 9 is a top, perspective view of an alternate embodiment of the container of the present invention with the funnel shown in the normal configuration.

FIG. 10 is a top, perspective view of the container of FIG. 9 with the funnel shown in the inverted configuration.

FIG. 11 is a top, perspective view of the container of FIG. 9 with the plug removed.

FIG. 12 is a partial, side, plan view of the container of FIG. 9.

FIG. 13 is a partial, bottom, perspective view of the container of FIG. 9.

FIG. 14 is a bottom, perspective view of the container of FIG. 9 shown with parts separated.

FIG. 15 is a top, plan view of the container of FIG. 9 shown with one embodiment of the plug.

FIG. 16 is a partial (longitudinal, vertical) cross-sectional view of the container of FIG. 9 taken along line 16-16 in FIG. 15.

### DETAILED DESCRIPTION

The present invention provides a freestanding container that is supportable on a surface in an unassisted, freestanding, upright (vertical) orientation and which includes an integrated funnel that is reconfigurable between a normal configuration and an inverted configuration. In the inverted configuration, the funnel facilitates filling and emptying of the container and inhibits (e.g., prevents) spillage, thereby increasing the safety of the container when used with heated fluid(s).

The freestanding capability of the container, the thickness thereof, and the inclusion of the integrated funnel increase not only the safety of the container, as indicated above, but the versatility of the container across a wide range of therapeutic and practical use cases including fluid consumption as well as personal warmth (e.g., a warming pad) and comfort in adults, children, and animals. For example, the container may be utilized to alleviate muscle and/or joint pain, relieve soreness, arthritis, headaches, menstrual cramping, etc. by providing targeted heat therapy, help treat injuries (e.g., bruises, muscle sprains, swelling, etc. by providing targeted heat therapy or cold water to provide a cold compress (first aid applications)), and reduce (if not entirely eliminate) the need for heating systems in beds, and provide heat in sleeping bags, tents, hunting blinds, etc.

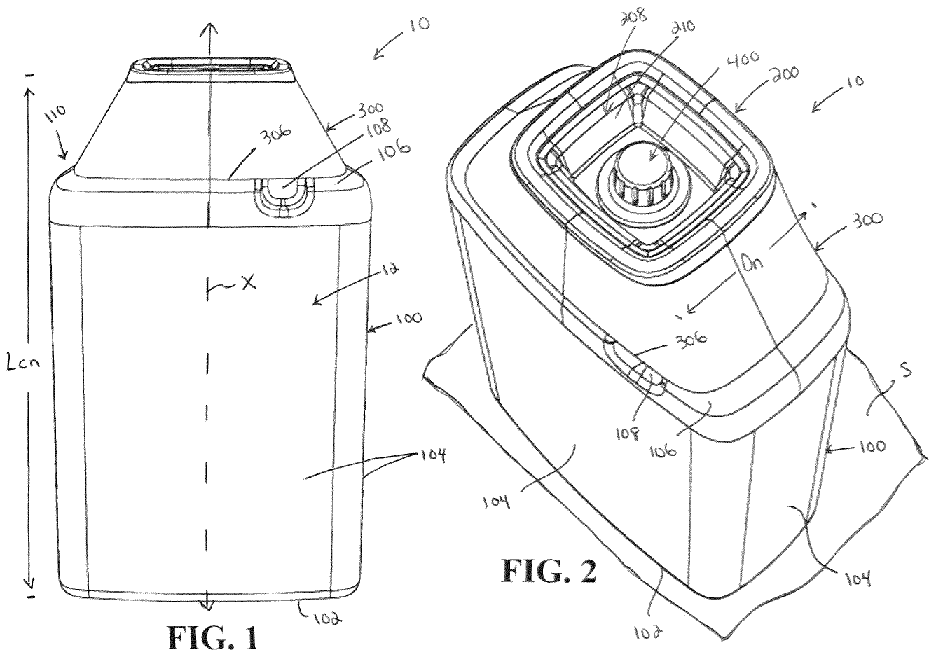

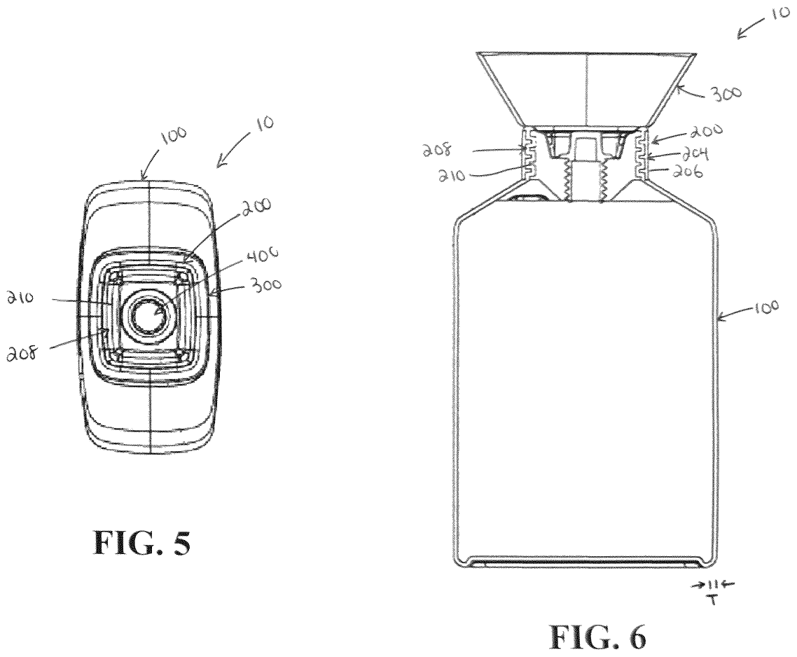

With reference now to FIGS. 1-8, an embodiment of the container, designated generally by reference numeral 10, is illustrated that includes: a bladder 100, which retains (stores) fluid(s) therein; a neck 200; an integrated funnel 300, which directs fluid into and out of the bladder 100 in order to facilitate filling and emptying of the container 10; and a plug 400. The container 10 defines a longitudinal axis X (FIG. 1) and is formed from (one or more) at least one flexible (i.e., non-rigid) food-grade materials (e.g., silicone), which allows for use of the container 10 with both hot and cold fluids. Although generally illustrated as a canteen 12, it is envisioned that the particular configuration of the container 10 may be varied without departing from the scope of the present disclosure. For example, embodiments in which the container 10 may be configured as a bottle, a flask, etc., are also envisioned herein.

In the illustrated embodiment, the container 10 has a capacity that lies substantially within the range of approximately 2 L to approximately 3 L and defines a generally uniform wall thickness T (FIG. 6) that lies substantially within the range of approximately 0.125″ to approximately 0.25″, which increases the durability and the insulative performance of the container 10 in order to reduce thermal loss, thereby maintaining the temperature of the fluid(s) within the container 10 over an extended period of time, and protect the user during handling (i.e., when the container 10 is used with heated fluid(s)). However, embodiments in which the container 10 may be configured such that the capacity and/or the thickness T lies outside the disclosed range are also envisioned herein (e.g., depending upon the intended use of the container 10).

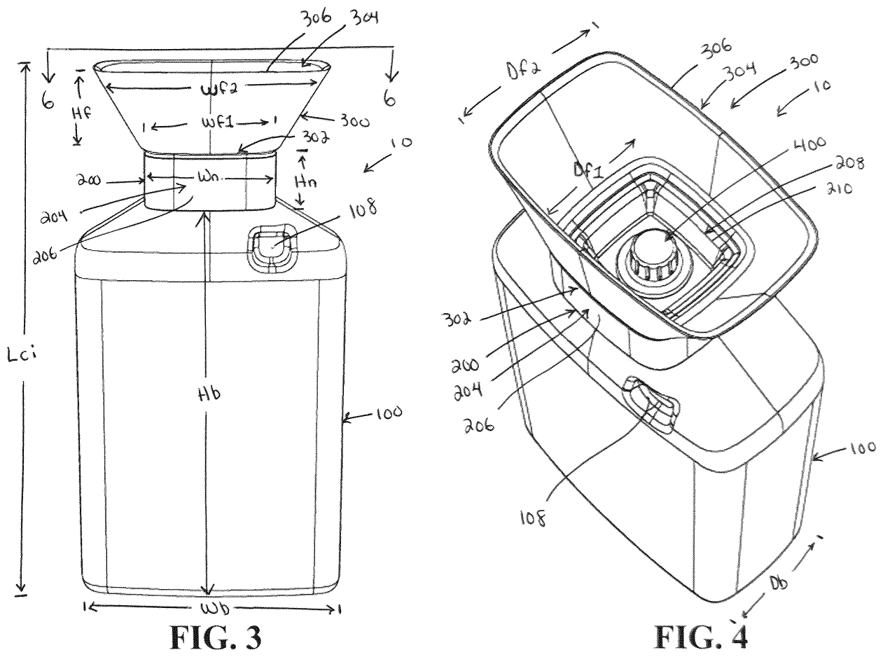

The bladder 100 defines: a height Hb (FIG. 3); a width Wb; and a depth Db (FIG. 4) and includes a base 102 and sidewalls 104 that extend (vertically) from the base 102.

In the illustrated embodiment, the container 10 is configured such that the height Hb lies substantially within the range of approximately 9″ to approximately 10″, the width Wb lies substantially within the range of approximately 5″ to approximately 7″, the depth Db lies substantially within the range of approximately 3″ to approximately 4″. However, embodiments in which the container 10 may be configured such that one or more of the height Hb, the width Wb, or the depth Db lies outside the disclosed range are also envisioned herein (e.g., depending upon the intended use of the container 10).

The base 102 is configured to support the container 10 on a surface S (e.g., table, counter, etc.) (FIG. 2) in an unassisted, freestanding, vertical orientation, as seen in FIG. 2, which increases both the stability and the safety of the container 10. For example, the freestanding capability of the container 10 allows the container 10 to remain upright absent handling by the user in order to inhibit (e.g., prevent) spillage during filling of the container 10 (e.g., with heated fluid(s)) and reduce spillage while filling and emptying.

In the illustrated embodiment, the base 102 is generally planar (flat) in configuration. Embodiments in which the base 102 may be non-planar in configuration are also envisioned herein. For example, an embodiment in which the base 102 may include a plurality of feet that extend (vertically) therefrom (i.e., away from the funnel 300) would not be beyond the scope of the present disclosure.

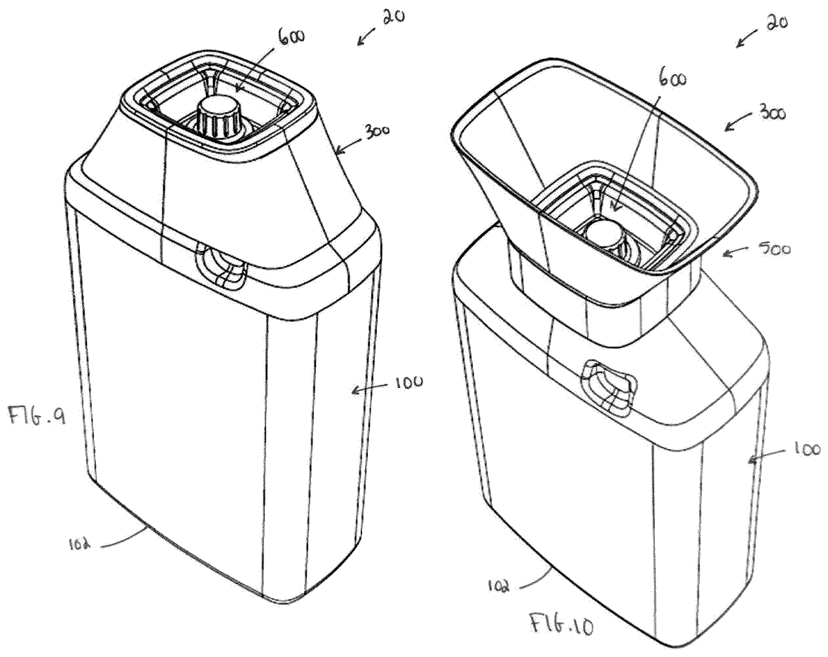

The neck 200 (FIG. 3) extends (vertically) from the bladder 100 (i.e., away from the base 102) and is directly connected (secured) to both the bladder 100 and the funnel 300 such that the neck 200 is positioned (located) therebetween. The neck 200 defines: a height Hn (FIG. 3); a width Wn; and a depth Dn (FIG. 2) and includes an opening 202 (FIG. 8), which facilitates filling and emptying of the container 10.

In the illustrated embodiment, the container 10 is configured such that the opening 202 defines a diameter Do (FIG. 8) that lies substantially within the range of approximately 0.75″ to approximately 1″, such that the height Hn lies substantially within the range of approximately 1″ to approximately 1.5″, the width Wn lies substantially within the range of approximately 2.5″ to approximately 3.5″, and the depth Dn lies substantially within the range of approximately 2.5″ to approximately 3″. However, embodiments in which the container 10 may be configured such that one or more of the diameter Do, the height Hn, the width Wn, or the depth Dn lies outside the disclosed range are also envisioned herein (e.g., depending upon the intended use of the container 10).

The neck 200 is configured to receive (interface with) the plug 400 such that the plug 400 is removably insertable into the opening 202, as described in further detail below, and includes a body 204 (e.g., an outer sleeve 206) and an insert 208 (e.g., an inner frame 210).

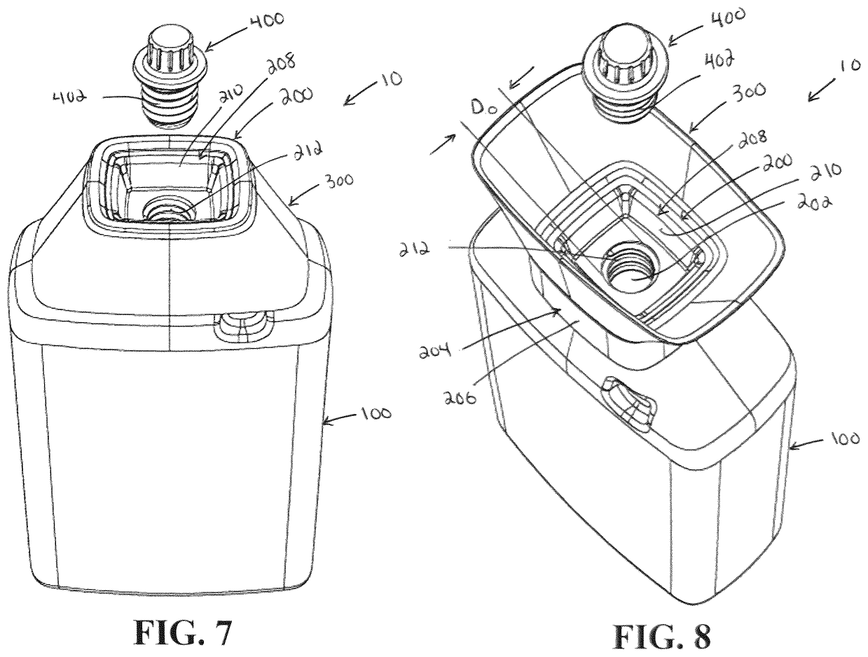

The insert 208 is positioned (located) within the body 204 and is connected (secured) thereto. The insert 208 defines the opening 202 and includes threading 212 (FIGS. 7, 8), which extends about the opening 202 and is configured for engagement with corresponding threading 402 on the plug 400 such that the neck 200 and the plug 400 are configured for threaded engagement.

In the illustrated embodiment, the body 204 is formed from a first material with a first durometer (i.e., the aforementioned flexible food-grade material), and the insert 208 is formed from a second, different food-grade material with a second, higher durometer (e.g., a plastic material, a polymeric material, a metallic material, a composite material, etc.), which facilitates connection of the plug 400 to the neck 200. Embodiments of the container 10 that are devoid of the insert 208 and which are formed from a single material (i.e., the aforementioned flexible food-grade material) are also envisioned herein (e.g., to reduce the cost and/or the manufacturing complexity of the container 10). For example, in such embodiments, it is envisioned that the threading 212 may be included on the body 204 such that the plug 400 is directly connectable thereto in threaded engagement.

The insert 208 and/or neck can be made of plastic or a firmer silicone for safety to hold the plug waterproof tight, although other materials are also contemplated.

With reference now to FIGS. 1-4 in particular, the funnel 300 will be discussed, which is integrated into the container 10 by forming the bladder 100, the neck 200 (e.g., the body 204), and the funnel 300 from a single piece of material (i.e., such that the container 10 is unitary (integral, monolithic) in construction).

The funnel 300 defines a height Hf (FIG. 3) and is layered in construction, which not only promotes smoother fluid flow in order to enhance the user experience during filling and emptying of the container 10 but further increases the safety of the container 10 by further inhibiting (e.g., preventing) spillage during filling of the container 10 (e.g., with heated fluid(s)). It allows for easy, fast and safe filling, reducing the risk of spills and minimizing the potential for burns from hot liquid. It enables filling the bottle without close hand contact with the hot liquid.

The funnel 300 includes a lower (first, attached) end 302 (FIGS. 3, 4) and an upper (second, free) end 304 that defines a rim 306.

The lower end 302 of the funnel 300 extends from the neck 200 and is directly connected (secured) thereto, as indicated above, whereby the funnel 300 is indirectly connected (secured) to the bladder 100 via the neck 200. As seen in FIGS. 3 and 4, the lower end 302 defines a width Wf1 and a depth Df1.

The upper end 304 of the funnel 300 (e.g., the rim 306) defines a width Wf2 and a depth Wd2. Whereas the depths Wd1, Wd2 are approximately equal, the width Wf2 exceeds the width Wf1 such that the funnel 300 includes a tapered configuration with a cross-sectional dimension that increases from the lower end 302 towards the upper end 304.

In the illustrated embodiment, the container 10 is configured such that the height Hf lies substantially within the range of approximately 1.5″ to approximately 2″, such that the width Wf1 generally corresponds to (mirrors, matches) the width Wn of the neck 200 and lies substantially within the range of approximately 2.5″ to approximately 3.5″, the depth Df1 generally corresponds to (mirrors, matches) the depth Dn (FIG. 2) of the neck 200 and lies substantially within the range of approximately 2.5″ to approximately 3″, the width Wf2 lies substantially within the range of approximately 4.5″ to approximately 5.5″, and the depth Df2 lies substantially within the range of approximately 2.5″ to approximately 3.5″ and is less than the depth Db (FIG. 4) of the bladder 100. However, embodiments in which the container 10 may be configured such that one or more of the height Hf, the width Wf1, the depth Df1, the width Wf2, or the depth Df2 lies outside the disclosed range are also envisioned herein (e.g., depending upon the intended use of the container 10).

The funnel 300 is reconfigurable between a normal configuration (FIGS. 1, 2), in which the funnel 300 extends towards the bladder 100 (i.e., such that the rim 306 is oriented towards the base 102 and engages (contacts) an outer surface 106 of the bladder 100), and an inverted configuration (FIGS. 3, 4), in which the funnel 300 extends away from the bladder 100 (i.e., such that the rim 306 is oriented away from the base 102 and is spaced (separated) from the bladder 100 along the longitudinal axis X (FIG. 1)) to thereby direct fluid into and out of the bladder 100 and facilitate filling and emptying of the container 10.

In the illustrated embodiment, in the normal configuration, the container defines a length Lcn (FIG. 1) that lies substantially within the range of approximately 10″ to approximately 11.5″, and in the inverted configuration, the container 10 defines a length Lci (FIG. 3) that lies substantially within the range of approximately 11.5″ to approximately 13.5″. However, embodiments in which the container 10 may be configured such that one or more of the length Lcn and the length Lci lies outside the disclosed range are also envisioned herein (e.g., depending upon the intended use of the container 10), however.

In order to facilitate reconfiguration of the funnel 300 from the normal configuration into the inverted configuration, in the illustrated embodiment, the bladder 100 defines a recess 108 (FIGS. 1-4) forming a finger flap, which is positioned (located) at (adjacent to) an upper end 110 of the bladder 100. The recess 108 is configured to receive one or more of the user's fingers in order to facilitate tactile engagement of the funnel 300 by the user and to facilitate inversion of the funnel 300 by the user (e.g., repositioning of the funnel 300 from the normal configuration into the inverted configuration). Thus, the user with the finger(s) engaged, manipulates the funnel, e.g., applies a force to the funnel, to invert the funnel 300 for filling.

In certain embodiments, it is envisioned that the container 10 may include an attachment structure (mechanism) (e.g., a clip) that is configured to removably connect the container 10 to an accessory. For example, it is envisioned that the attachment structure may be configured to facilitate connection of the container 10 to a body pillow, a sleeping bag, a user's clothing, etc., in order to warm or cool the accessory and/or the user (e.g., to increase comfort and/or soothe maladies).

Additionally, or alternatively, it is envisioned that the container 10 may include a harness with (one or more) at least one (adjustable) strap (e.g., a belt, a band, etc.) to allow the container 10 to be worn by the user in order to warm or cool the user (e.g., to increase user comfort and/or soothe maladies). In such embodiments, it is envisioned that the overall size (i.e., the capacity) of the container 10 may be reduced in order to increase wearability and portability.

The container can also be used in some embodiments as a drinking liquid container.

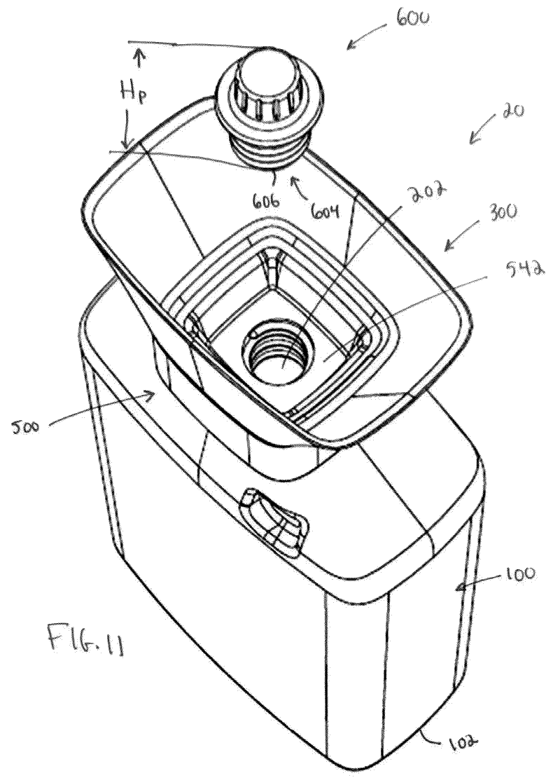

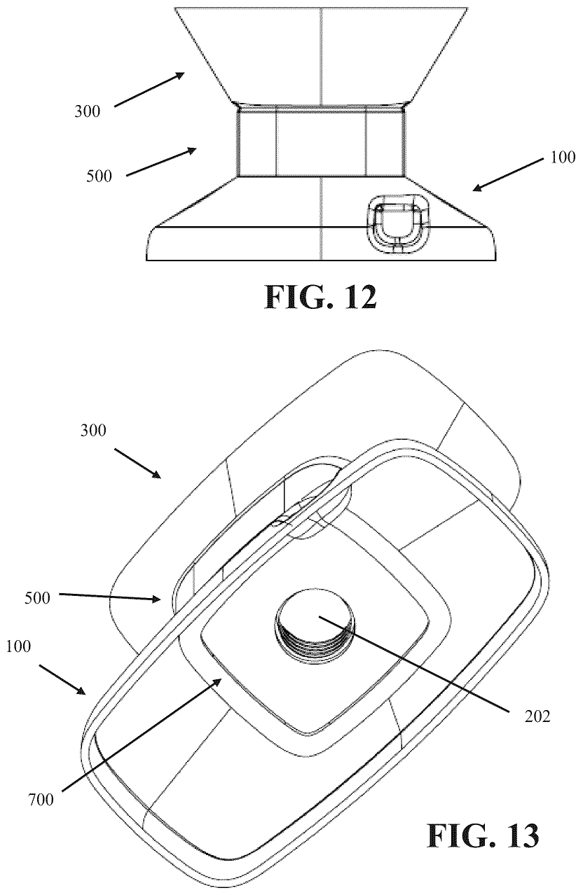

With reference now to FIGS. 9-16, a container 20 is illustrated, which is an alternate embodiment of the container 10 (FIGS. 1-8) discussed above. The container 20 is substantially similar in both structure and function to the container 10 and, accordingly, in the interest of brevity, will only be discussed with respect to certain differences therefrom. As such, like reference characters will be utilized to identify structure, elements, and features common to the container 10 and the container 20.

The container 20 includes: the bladder 100; the integrated funnel 300; a neck 500; a plug 600; and an internal cover plate 700.

The neck 500 includes the opening 202 (FIGS. 11, 13) and is configured to receive (interface with) the plug 600 such that the plug 600 is removably (e.g., threadedly) insertable into the opening 202, as discussed above in connection with the container 10 (FIGS. 1-8). The neck 500 includes: a body 504; an outer sleeve 506; and an insert 508. The body 504, the outer sleeve 506, and the insert 508 are arranged concentrically such that the body 504 is positioned (located) radially between the outer sleeve 506 and the insert 508.

The body 504 of neck 500 supports and is directly connected (secured) to the bladder 100, the funnel 300, the outer sleeve 506, and the insert 508, as described in further detail below. More specifically, the body 504 extends (vertically) from the bladder 100 (i.e., away from the base 102) and is positioned (located) (vertically) between the bladder 100 and the funnel 300. The bladder 100, the funnel 300, and the neck 500 (e.g., the body 504) are each integrated into the container 20 by forming the bladder 100, the funnel 300, and the neck 500 (e.g., the body 504) from a single piece of material.

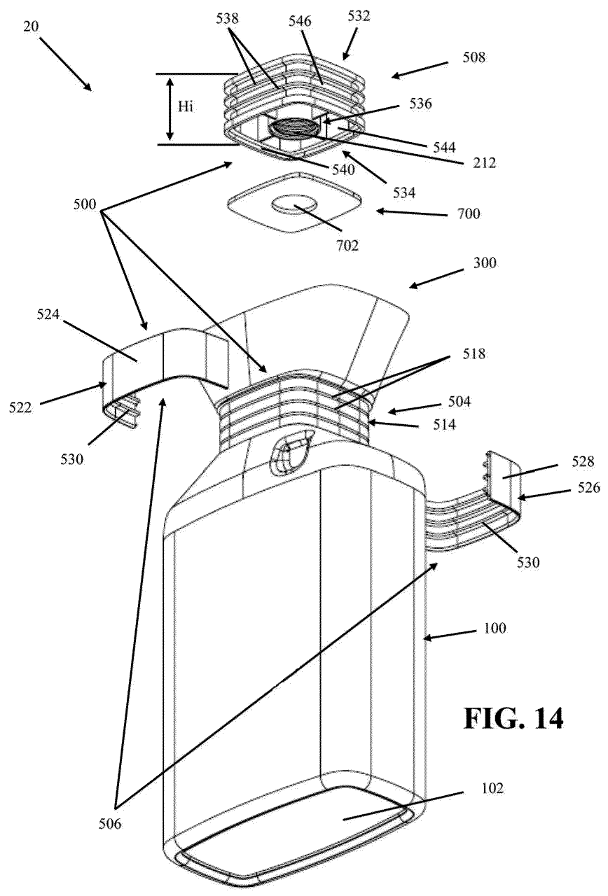

As seen in FIGS. 14 and 16, the body 504 includes an outer surface 514 and an inner surface 516, each of which is corrugated in configuration. More specifically, the outer surface 514 and the inner surface 516 include external (exterior) ridges 518 and internal (interior) ridges 520, respectively, which facilitate assembly of the container 20, as described in further detail below.

The outer sleeve 506 extends about (e.g., encloses, circumscribes partially or entirely) the body 504 and increases the structural rigidity of the neck 500 (e.g., in order to facilitate repositioning of the funnel 300 between the normal configuration and the inverted configuration). The outer sleeve 506 includes a first section 522 (FIG. 14) (e.g., a first collar 524) and a second section 526 (e.g., a second collar 528) that are configured for connection during manufacturing of the container 20 (e.g., via an adhesive, ultrasonic welding, etc.), which facilitates and simplifies assembly of the container 20.

The outer sleeve 506 (e.g., the first section 522 and the second section 526) includes ribs 530 (FIG. 14) that extend (radially) inward therefrom. The ribs 530 correspond in configuration to (e.g., generally match the configuration of) the external ridges 518 on the body 504, which facilitates proper engagement and connection of the outer sleeve 506 and the body 504. More specifically, upon assembly of the container 20, the ribs 530 extend into the external ridges 518, as seen in FIG. 16.

The insert 508 is substantially similar in both structure and function to the insert 208 (FIGS. 1-8) discussed above and, accordingly, in the interest of brevity, will only be discussed with respect to certain differences therefrom. As such, like reference characters will be utilized to identify structure, elements, and features common to the insert 208 and the insert 508.

Relative to the insert 208, the insert 508 includes a reduced height Hi (FIG. 14) that lies substantially within the range of approximately 1.00″ to approximately 1.50,″ and preferably approximately 1.20″, which inhibits (e.g., prevents) water from being trapped within the insert 508.

The insert 508 defines the opening 202, which extends therethrough, and includes: an upper end 532; a lower end 534; a socket 536; and ribs 538.

The lower end 534 is positioned opposite to the upper end 532 and defines a recess 540 (FIGS. 14, 16). The recess 540 receives the cover plate 700 such that the cover plate 700 extends (vertically) into and is positioned within the insert 508, as described in further detail below. The lower end 534 is positioned adjacent to (e.g., is in engagement (contact) with) and is supported by an (internal) flange 112 (FIG. 16) on the bladder 100, which extends (radially) inward from the sidewalls 104 at the upper end 110 thereof.

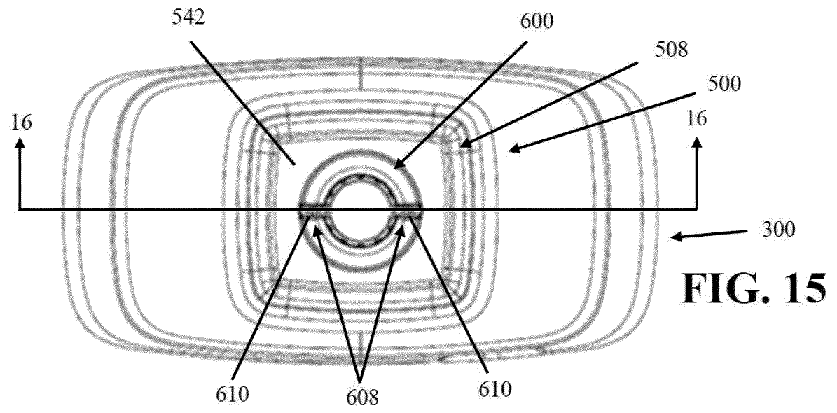

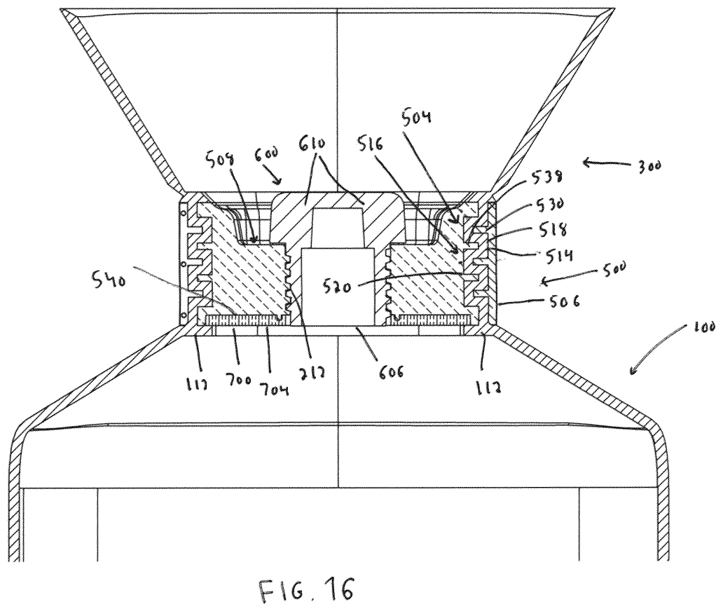

The socket 536 extends (vertically downward) from and end wall 542 (FIGS. 11, 15) of the insert 508, which is positioned (located) between the respective upper and lower ends 532, 534 thereof, so as to define a hollow interior region 544 (FIG. 14) within the insert 508. The socket 536 includes the threading 212, which facilitates connection of the insert 508 and the plug 600, as discussed above.

The ribs 538 (FIG. 14) extend (radially) outward from an outer wall 546 of the insert 508 and correspond in configuration to (e.g., generally match the configuration of) the internal ridges 520 on the body 504, which facilitates proper engagement and connection of the insert 508 and the body 504. More specifically, upon assembly of the container 20, the ribs 538 extend into the internal ridges 520, as seen in FIG. 15.

The plug 600 is substantially similar in both structure and function to the plug 400 (FIGS. 1-8) discussed above and, accordingly, in the interest of brevity, will only be discussed with respect to certain differences therefrom. As such, like reference characters will be utilized to identify structure, elements, and features common to the plug 400 and the plug 600.

Relative to the plug 400, the plug 600 includes a reduced height Hp (FIG. 11) that lies substantially within the range of approximately 1.10″ to approximately 1.60,″ and is preferably approximately “1.25.” such that, upon insertion of the plug 400 into the opening 202, a lower end 604 (e.g., a bottom surface 606) of the plug 600 extends into but not beyond the cover plate 700, as described in further detail below.

In order to facilitate insertion of the plug 600 into the opening 202 and connection of the plug 600 to the neck 500, in one embodiment, the plug 600 includes one or more tactile members 608 (FIG. 15) (e.g., wings 610), which facilitate the application of force (e.g., torque) to the plug 600.

The cover plate 700 is positioned (located) within the recess 540, as indicated above, and conceals (closes) the hollow interior region 544 (FIG. 14) in order to further inhibit (e.g., prevent) water from being trapped within the insert 508 (e.g., about the socket 536). More specifically, upon assembly of the container 20, the cover plate 700 is positioned adjacent to (e.g., is in engagement (contact) with) and is supported by the flange 112 (FIG. 14) at the upper end 110 of the bladder 100.

In the illustrated embodiment, the cover plate 700 is fixedly (e.g., non-removably) connected to the insert 508 (e.g., via an adhesive, ultrasonic welding, etc.). Embodiments in which the cover plate 700 may be removable from the insert 508 are also envisioned herein, however.

The cover plate 700 includes an aperture 702 (FIG. 14) that receives the socket 536. More specifically, upon assembly of the container 20, the socket 536 extends into the aperture 702 such that the lower end 604 (e.g., the bottom surface 606) of the plug 600 is generally flush with a bottom surface 704 of the cover plate 700 (e.g., such that the bottom surface 606 of the plug 600 and the bottom surface 704 of the cover plate 700 are arranged in generally coplanar relation), as seen in FIG. 16.

In use, like container 10, the user manipulates the funnel 300, e.g., manually moves (or applies a force) to move the funnel 300 between the inverted a non-inverted positions as needed.

Although the systems, components, and methods described herein above relate to certain embodiments of the disclosure, those skilled in the art will readily appreciate that changes and modifications may be made thereto without departing from the spirit and scope of the present invention as defined by the appended claims. Persons skilled in the art will understand that the various embodiments of the disclosure described herein and shown in the accompanying figures constitute non-limiting examples, and that additional components and features may be added to any of the embodiments discussed herein without departing from the scope of the present invention.

It will be understood by those skilled in the art that the above particular embodiments are shown and described by way of illustration only. The principles and the features of the present disclosure may be employed in various and numerous embodiments thereof without departing from the scope and spirit of the invention as claimed. The above-described embodiments do not restrict the scope of the invention.

Additionally, persons skilled in the art will understand that the elements and features shown or described in connection with one embodiment may be combined with those of another embodiment without departing from the scope of the present invention.

Throughout the present disclosure, terms such as “approximately,” “about”, “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in which the pertinent components are oriented so as to define an angle therebetween that is equal to 180°±25% (e.g., an angle that lies within the range of (approximately) 135° to (approximately) 225°) and the term “generally orthogonal” should be understood as referring to configurations in with the pertinent components are oriented so as to define an angle therebetween that is equal to 90°±25% (e.g., an angle that lies within the range of (approximately) 67.5° to (approximately) 112.5°).

The recitation of numerical ranges by endpoints includes all numbers within the range.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A container for storing fluid comprising:
a bladder including a base configured to support the container in a freestanding, vertical orientation absent handling by a user;
a neck extending from the bladder, wherein the neck defines an opening to facilitate filling and emptying of the container;
a funnel extending from the neck such that the neck is positioned between the bladder and the funnel, wherein the funnel defines a rim and is reconfigurable between a normal configuration, in which the rim is oriented towards the base, and an inverted configuration, in which the rim is oriented away from the base to facilitate filling and emptying of the container; and
a plug configured for removable insertion into the opening.

2. The container of claim 1, wherein the bladder, the neck, and the funnel are formed from a single piece of material.

3. The container of claim 1, wherein the funnel is configured such that the rim contacts an outer surface of the bladder in the normal configuration.

4. The container of claim 1, wherein the neck and the plug are configured for threaded engagement.

5. The container of claim 1, wherein the neck includes:
a body; and
an insert positioned within the body, wherein the insert defines the opening.

6. The container of claim 5, wherein the body is formed from a first material, and the insert is formed from a second material different from the first material.

7. The container of claim 6, wherein the first material has a first durometer, and the second material has a second durometer higher than the first durometer.

8. The container of claim 5, further comprising a cover plate positioned within the insert.

9. The container of claim 8, wherein the cover plate is fixedly connected to the insert.

10. The container of claim 8, wherein the cover plate defines an aperture, and the plug extends into the aperture.

11. A container for storing fluid comprising:
a bladder; and
a funnel connected to the bladder and reconfigurable between a normal configuration and an inverted configuration.

12. The container of claim 11, wherein the bladder defines a recess configured to facilitate tactile engagement of the funnel by a user and repositioning of the funnel from the normal configuration into the inverted configuration.

13. The container of claim 11, wherein the container is configured for use in a freestanding, upright orientation.

14. The container of claim 11, wherein the funnel includes a rim and is configured such that, in the normal configuration, the rim contacts an outer surface of the bladder, and, in the inverted configuration, the rim is spaced from the bladder along a longitudinal axis of the container.

15. The container of claim 11, further comprising:
a neck connecting the funnel to the bladder.

16. The container of claim 15, wherein the bladder, the neck, and the funnel are formed from a single piece of material.

17. The container of claim 16, wherein the container is formed from a food-grade material.

18. A container for storing fluid comprising:
a bladder;
a neck connected to the bladder, wherein the neck includes:
a body; and
an insert positioned within the body and defining an opening to facilitate filling and emptying of the container; and
a funnel connected to the neck, wherein the bladder, the neck, and the funnel are from a single piece of material such that the funnel is integrated into the container.

19. The container of claim 18, wherein the body includes a first material, and the insert includes a second material different from the first material.

20. The container of claim 18, wherein the funnel is reconfigurable between a normal configuration, in which the funnel extends towards the bladder, and an inverted configuration, in which the funnel extends away from the bladder.
